(19) United States
(12) Patent Application Publication
(10) Pub. No.: US 2015/0221016 A1
(43) Pub. Date: Aug. 6, 2015

(54) SYSTEMS AND METHODS FOR FACILITATING EFFICIENT SHOPPING

(71) Applicants: Egan Schulz, San Jose, CA (US); Michelle Serrano, San Jose, CA (US); Neelakantan Sundaresan, Mountain View, CA (US); Libo Su, San Jose, CA (US); Sandy Lynn Godsey, San Jose, CA (US); David Edward Eramian, San Jose, CA (US); Dane Glasgow, Los Altos, CA (US)

(72) Inventors: Egan Schulz, San Jose, CA (US); Michelle Serrano, San Jose, CA (US); Neelakantan Sundaresan, Mountain View, CA (US); Libo Su, San Jose, CA (US); Sandy Lynn Godsey, San Jose, CA (US); David Edward Eramian, San Jose, CA (US); Dane Glasgow, Los Altos, CA (US)

(21) Appl. No.: 14/169,704

(22) Filed: Jan. 31, 2014

(51) Int. Cl. G06Q 30/06; G06Q 50/00

(52) U.S. Cl. CPC G06Q 30/0633; G06Q 30/0631; G06Q 50/01

(57) ABSTRACT

Systems and methods are provided for facilitating efficient shopping for a user. A real or virtual shopping cart can be pre-filled for a user before the user arrives at a merchant location. The shopping cart can be pre-filled with items that are based on the user's previous behavior and/or purchases. The items can include repeat purchase items that the user has repeatedly purchased at the merchant and is likely to purchase again. The system may generate smart shopping lists that can be used to pre-fill the shopping cart. The smart shopping list may include user selected items, repeat purchase items, predicted items for the user, and/or merchant recommended items. The items can be provided in corresponding sections of the shopping cart. The system can also offer to deliver the items to the user and to pick up and deliver additional items along a delivery route for the user.

### BACKGROUND

1. Field of the Invention

The present invention generally relates to electronic commerce and, more particularly, to systems and methods for facilitating efficient shopping.

2. Related Art

Computer systems and networks can facilitate the tasks of buying, selling and transferring goods and services in retail and other marketplaces. For example, a consumer can pay for an item from either an online merchant or at a point of sale of a brick-and-mortar store through the use of a payment provider that can be accessed on his or her smart phone, tablet, laptop computer, desktop computer, or other personal mobile or desktop device. In particular, users of a payment provider can use the payment provider website or a payment provider application or “app” on a mobile device to make payments to various online or offline merchants.

In some situations, a shopper knows in advance some or all of the items they want to buy before visiting an online merchant or a brick-and-mortar merchant location. In many cases, these items can be the same from visit to visit. For example, when a person goes to a grocery store each weekend, they will inevitably buy some of the same items such as bread, milk, etc. each week. However, each time the shopper visits the merchant, they have to locate each item and place it in a real or virtual shopping cart before purchasing the item. This can be time consuming and can reduce the time and energy a shopper has at the merchant to shop for other, possibly higher value items.

It would be therefore be desirable to provide improved systems and methods for efficient shopping.

### BRIEF DESCRIPTION OF THE FIGURES

FIG. 1 is a block diagram of an illustrative networked system suitable for implementing a process for efficient shopping according to an embodiment.

FIG. 2 is a diagram of an illustrative shopping cart showing how one or more items may be pre-populated in various sections of the cart for a user according to an embodiment.

FIG. 3 is a top view diagram of an illustrative shopping cart showing how pre-populated items in the cart may be arranged in sections in the cart based on the type of item according to an embodiment.

FIG. 4 is a diagram of an illustrative user device display showing how a merchant interface may include a pre-populated virtual shopping cart for a user according to an embodiment.

FIG. 5 is a diagram illustrating how a smart shopping list may be transfonned into a computer readable code according to an embodiment.

FIG. 6 is a diagram of an illustrative merchant location showing how a virtual perimeter around the merchant location may be used to initiate user transactions according to an embodiment.

FIG. 7 is a flowchart showing an illustrative process for pre-filling a user shopping cart according to an embodiment.

FIG. 8 is a flowchart showing an illustrative process for predicting items for a user based on a detected user behavior according to an embodiment.

FIG. 9 is a flowchart showing an illustrative process for predicting items for a user based on detected user movements according to an embodiment.

FIG. 10 is a flowchart showing an illustrative process for generating a smart shopping list and an associated computer readable code according to an embodiment.

FIG. 11 is a flowchart showing an illustrative process for providing user discounts associated with bundled items in a pre-populated shopping cart according to an embodiment.

FIG. 12 is a block diagram of a computer system suitable for implementing one or more components in FIG. 1 according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for performing transactions such as pre-filled shopping cart and/or smart shopping list transactions. In various particular embodiments, the devices, systems or methods can involve one or more devices in communication over a network. Such devices, systems, and methods can facilitate the generation and maintenance of smart shopping lists, and pre-filling of shopping orders (e.g., by pre-filling a real or virtual shopping cart). According to an embodiment, a smart shopping list may include a list of items selected by a user, predicted items for the user such as repeat purchase items that the user has repeatedly purchased or other predicted items for the user, merchant-recommended items for the user, and/or other items. The user selected items may be items directly selected by the user. The repeat purchase items may be items that the user purchases on substantially every occasion on which the user visits the real or online merchant. The other predicted items may include items that the user has previously purchased that the system determines based on an elapsed time or based on other purchases that may have run out or items that, based on detected behavior of the user or other purchase history, the user may need and may not remember (as examples). The merchant-recommended items may include new items for sale, discounted items, items to be bundled with user selected, repeat purchase, and/or user predicted items, gift items based on user contacts calendars or behaviors, or other items that the user may not have previously purchased, but that the user may have an interest in purchasing.

While many of the various examples disclosed herein focus on particular aspects regarding the online transactions, it will be understood that the various inventive principles and embodiments disclosed herein can be applied to other types of transactions and arrangements as well. For example, a purchase that is performed in person using an online payment provider for payment may utilize one or more of the aspects and features found in the various systems and methods provided.

References throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these are not necessarily all referring to the same embodiment. Furthermore, the particular features, structures or characteristics may be combined in any suitable manner in one or more embodiments.

According to an embodiment, a computer program product can comprise a non-transitory machine readable medium. The non-transitory machine readable medium can have computer readable and executable code for instructing one or more processors to perform any of the methods disclosed herein.

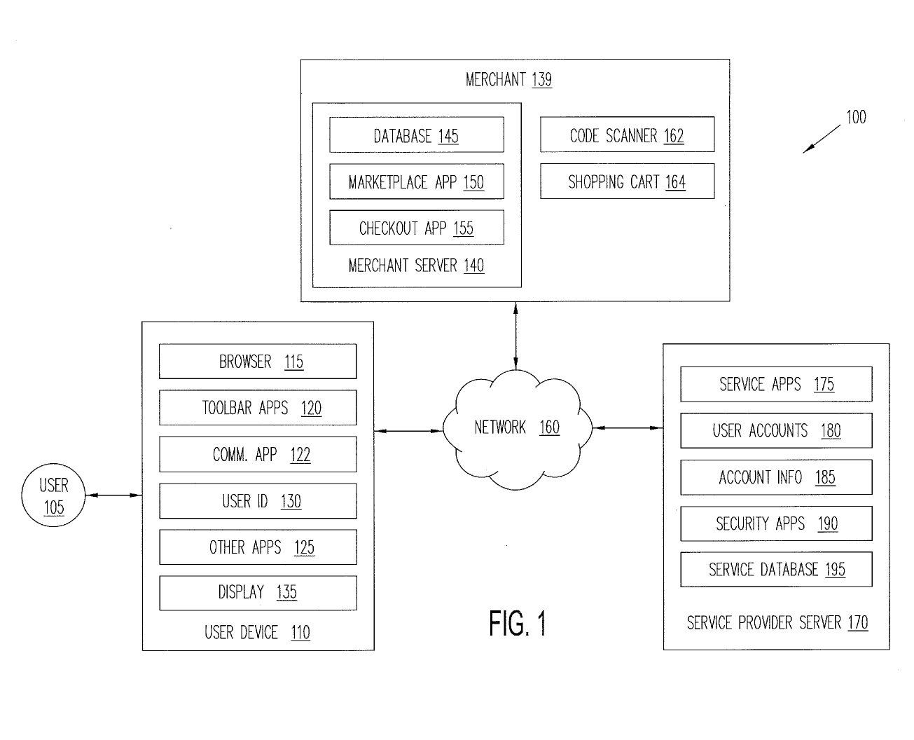

Beginning with FIG. 1, a block diagram is shown of a networked system 100 suitable for implementing a process for facilitating efficient shopping according to an embodiment. Networked system 100 may comprise or implement a plurality of servers and/or software components that operate to perform various electronic commerce transactions or processes such as payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140 of a merchant 139, and a service provider server 170 (e.g., a payment provider server) in communication over a network 160. Payment provider server 170 may be maintained by a payment service provider, such as PayPal, Inc. of San Jose, Calif. A user 105, such as a sender or consumer, utilizes user device 110 to perform a transaction such as an electronic commerce transaction using payment provider server 170. A user 105 may utilize user device 110 to initiate a payment transaction, receive a transaction approval request, or reply to the request. Note that transaction, as used herein, refers to any suitable action performed using the user device, including payments, transfer of information, display of information, purchases, sales, online listings, smart list transaction, pre-filled order transactions, etc. For example, user 105 may utilize user device 110 to initiate a deposit into a savings account. Although only one merchant server is shown, a plurality of merchant servers may be utilized if the user is purchasing products or services from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, manage smart shopping lists, and otherwise utilize a smart wallet through the payment provider as discussed above. User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 also may include components and applications that generate and/or display a computer readable code based on a smart shopping list. For example, user device 110 may include a touch screen that displays information such as a scannable code to user 105 and receives user input from user 105.

User derive 110 also may collect location data using Global Positioning System (GPS) circuitry to identify a location of user device 110. Other means for collecting location data, such as WiFi devices, Near-Field Communication (NFC) devices, or the like also may be included in user device 110 for determining a location of user device 110. Thus, user device 110 may determine a current location of user device 110 based on the collected location data. In another embodiment, user device 110 may send the location data to payment provider server 170 and payment provider server 170 may determine a current location of user device 110 based on the location data.

Merchant server 140 may be maintained, for example, by a merchant or seller such as merchant 139 offering various products and/or services. The merchant 139 may have a physical point-of-sale (POS) store front at which one or more code scanners such as a code scanner 162 and one or more shopping carts 164 are located. However, this is merely illustrative. In some embodiments, shopping cart 164 may be a virtual shopping cart on a merchant website or an internal virtual shopping cart such as a purchase order for a user. Code scanner 162 may be configured to scan a code that is displayed on, for example, display 135 of user device 110. Merchant server 140 may be configured to provide a pre-filled shopping cart (e.g., a set of real or virtual items for purchase) to the user responsive to arrival information of the user (e.g., when the user scans a code using code scanner 162 or when it is determined that user device 110 is located near or approaching merchant 139). For example, a customer may have a smart shopping list in a user account 180 of payment provider server 170 or merchant server 140. Payment provider server 170 and/or merchant server 140, and/or an application running on user device 110 may generate a scannable code based on the smart shopping list. The user may scan the code using code scanner 162 when the user arrives at the (physical or virtual) merchant location. In response to receiving the scanned code, the merchant server may provide the user with a pre-filled order. The pre-filled order may include (as examples), a coffee drink made to the user's specifications at a coffee merchant, a real shopping cart that has been pre-filled by the merchant with items from the user's smart shopping list, or a virtual shopping cart that has been pre-filled by the merchant with items from the user's smart shopping list.

Code scanner 162 may be a visual code scanner or may receive a transmitted (e.g., radio frequency or microwave frequency) code transmitted by user device 110 automatically. For example, when the user is within a predetermined distance from a merchant location, the user device may transmit information such as location information and/or the coded smart shopping list to the merchant so that the pre-filled order is ready when the user arrives. Code scanner 162 may also receive visual or transmitted codes for payment. For example, when the user scans a code and/or leaves the merchant location (e.g., with the coffee drink or the shopping cart), code scanner 162 may automatically charge a user account of the user for the items (including, if desired, additional items chosen by the user while shopping at the merchant).

The merchant may be a participating merchant who has a merchant account with the payment service provider. Merchant server 140 may be used for POS or online purchases and transactions. Generally, merchant server 140 may be maintained by anyone or any entity that receives money, which includes charities as well as banks and retailers. For example, a payment may be a donation to charity or a deposit to a bank account such as a savings account.

Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like. Checkout application 155 may be coupled to a code reader such as code scanner 162.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Account information may also include smart shopping lists and/or preferences or settings for generating and maintaining smart shopping lists. Payment application 175 may be configured to interact with merchant server 140 on behalf of user 105 during a transaction with checkout application 155 to track and manage purchases made by users and which and when funding sources are used. Payment application 175 may be configured to determine the existence of and to manage accounts for user 105, as well as create new accounts if necessary. Payment application 175 may be configured to execute one or more payment transactions in response to receiving and recognizing, for example, a scanned code displayed on user device 110.

A transaction processing application 190, which may be part of payment application 175 or may be separate from application 175, may be configured to receive information from user device 110 and/or merchant server 140 for processing and storage in a service database 195 (e.g., a payment database). Transaction processing application 190 may include one or more applications for processing information from user 105 for processing an order and for payment using various selected funding instruments, including operations for initial purchase and for payment after purchase as described herein. As such, transaction processing application 190 may store details of an order from individual users, including a funding source used, available credit options, etc. Transaction processing application 190 may be configured to execute one or more transactions such as efficient shopping transactions in response to scanned and/or transmitted information such as coded shopping lists and/or location information from user 105.

One or more of merchant server 140, payment provider server 170, and user device 110 may be used to execute any suitable efficient shopping transaction or operation. In one particular situation that is sometimes discussed herein as an example, a user may arrive at a merchant location and provide information associated with an arrival of the user at the merchant to the merchant (e.g., by scanning a scannable code at the merchant or transmitting location information such as global positioning system data, perimeter crossing information, and/or arrival information to the merchant). Upon receiving the information, the merchant may fill and provide a pre-filled shopping cart with items for the user to the user. The merchant may fill the shopping cart at a time based on a common arrival time of the user at the merchant or when information such as arrival information is received. The merchant may automatically or manually deliver a shopping cart that has already been filled to the user upon receipt of the arrival information.

In one embodiment, the user may arrive at a coffee shop and scan a code that is displayed on the user's smartphone using a merchant code scanner. The scanned code may inform the merchant that the user wishes to order a particular coffee drink (e.g., a Grande Chai Tea Latte, 3 Pump, Skim Milk, Lite Water, No Foam, Extra Hot). In response to receiving the scanned code, the merchant can prepare the desired coffee drink and provide it to the user. In this way, the time it takes a customer to order an item can be reduced, the length of lines at the merchant can be reduced, errors in ordering complicated items such as the exemplary coffee drink above can be reduced, and the shopping experience of the customer can thereby be made generally more efficient. If desired, the checkout process can also be integrated into the code scanning operations so that the order is also paid (e.g., using a payment provider server) when the code is scanned. In this way, the order processing and checkout can be integrated into a single code (e.g., a quick response (QR) code or any other code). Complex ordering processes of this type can be prepared prior to arrival and transformed into a code so that, just by synching the code, the long lines at many offline stores can be avoided. An order for a repeat purchase item such as the exemplary coffee drink above can be provided by the user or can be automatically learned by the system based on a repeated purchase of the item when the user visits the merchant. The user may also be provided with the ability to edit a previously provided or learned order for a repeat purchase item. For example, in anticipation of arriving at the coffee merchant and receiving a pre-filled order for a repeat coffee drink, the user can edit the order on their user device and generate, for example, a new scannable code for the edited version of the order that can be used on a one-time or a repeating basis.

Individual codes for various users can also be generated and integrated (e.g., without sharing the details of each user's code with other users) to generate a meta-code which includes multiple individual orders. In this way, group shopping can be enabled that increases the ease of use, privacy and access control.

In another example, a user may frequently visit a grocery store or a big box store (e.g., the user may make weekly visits, daily visits, monthly visits, etc.) and may purchase common items during each visit. The system may learn (e.g., recognize) the repeat items and compile the repeat purchase items onto a smart shopping list. When the user arrives at, for example, the big box store, the user may scan a code that is displayed on the user's smartphone using a merchant code scanner. The scanned code may inform the merchant that the user wishes to retrieve a pre-filled shopping cart with the items on the smart shopping list pre-populated in the shopping cart. In response to receiving the scanned code, the merchant can obtain an already filled cart and provide the pre-filled cart to the user or the merchant can fill the cart at that time and provide the cart to the user. In this way, the time it takes a customer to shop for, for example, mundane, repeat items that the user repeatedly purchases may be reduced and the shopping experience of the customer can be thereby be made generally more efficient. The cart may also be pre-filled prior to the user arriving at the merchant location. For example, the user may notify the merchant and/or service provider that the user intends to be at the merchant by a certain time, such that the cart can be pre-filled prior to arrival. Notification can be through different means, such as, but not limited to, an automatic transmission of user location data from the user device, a text message to the merchant, a telephone call to the merchant, an email to the merchant, an online calendar application of the merchant (e.g., on a merchant webpage or other interface provided through a merchant and/or payment provider application running on the user device), an automatic transmission from a user device that the user has crossed a virtual perimeter around the merchant and/or is moving in the direction of the merchant or other electronic or in-person notification.

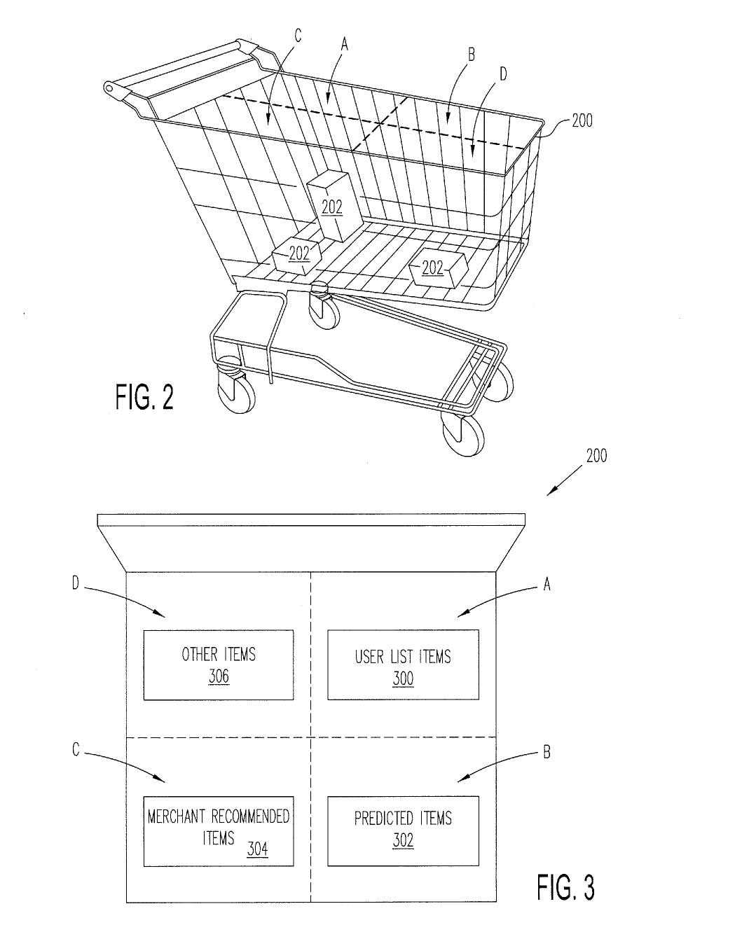

FIG. 2 shows an example of a pre-filled shopping cart. As shown in FIG. 2, a shopping cart such as a shopping cart 200 may be provided with one or more items 202. Items 202 may be pre-filled by a merchant in shopping cart 200 before the user arrives at the merchant location or when the user arrives at the merchant location. Items 202 may be items that are included on a smart shopping list of the user. Items 202 may have been placed on the smart shopping list by the user, learned by the system based on the purchase history of the user, predicted by the system based on the purchase history, consumption data, and/or other habits of the user, and/or recommended by the merchant for purchase by the user. As shown in FIG. 2, a shopping cart such as shopping cart 200 may be divided in to one or more sections such as sections A, B, C, and D (as examples). Sections A, B, C, and D may be physically separated (e.g., by a barrier) or may simply be organizational sections of cart 200.

FIG. 3 is a top view of shopping cart 200 showing how each section of shopping cart 200 may be used to place a corresponding type of item for the user. In this way, a pre-filled shopping cart may be provided to the user that allows the user to easily choose which items in the cart will actually be purchased. In the example of FIG. 3, section A of cart 200 includes user list items 300, section B includes other predicted items 302, section C includes merchant-recommended items 304, and section D includes other items 306.

User list items 300 may be items that were selected directly by the user and/or predicted items such as repeat purchase items that have been previously and repeatedly purchased by the user (e.g., on every visit or nearly every visit to the merchant). These items may include a repeat food or drink order, staple food and/or household items, office supplies, or any other items such as items that the user has authorized to always be included in a pre-filled shopping cart. Other predicted items 302 may be items that have been predicted for the user based on the user's purchase history and/or other behaviors or habits by, for example, a payment provider server. For example, if a user purchased lawn fertilizer in the spring of a given year, the system may predict that, in March of the following year, the user may again wish to purchase lawn fertilizer even though the user has only purchased lawn fertilizer on one other occasion.

In another example, the system may obtain information that the user has had a new baby (e.g., based on a recent purchase of infant clothes at another merchant, social media posts by the user, email exchanges by the user, etc.) and may include diapers in the pre-filled shopping cart (and/or on the user's smart shopping list), predicting that the user may need an item that has not been previously purchased or has not be recently or repeatedly purchased. Predicted items 302 may be determined based on a detected user behavior. For example, if the user is detected making unusual movements based on an obtained user location history, the system may predict items that the user may need based on that detected unusual movement.

Merchant-recommended items 304 may include items to be added to the user cart by the merchant such as items that the user has not previously purchased and/or items that the user may not be aware of such as newly released items, items that are currently discounted (e.g., sale items), promotional items, and/or items that are bundled together and/or bundled with one or more of user list items 300, predicted items 302, and/or other items 306. Bundled items may be items that, when purchased together, are offered at a discounted price. When the user is provided with bundled items in a pre-filled shopping cart, the user may be provided with a discount alert associated with the bundled items. The system may be configured to detect the user removing one or more items from a pre-filled shopping cart, and if a bundled item is removed, the user may be provided with an alert notifying the user that the discount may be lost if the bundled item is removed.

Other items 306 may include any other items that the user may wish to purchase such as items recommended by a friend, family member or other contact of the user, gifts for the user from user friends, family or other contacts, or other suitable items. Other items 306 may include items for a friend, a family member, or other contact of the user based on contact information obtained by the system an online social network of the user or from any other suitable indicator.

The shopping cart 200 of FIGS. 2 and 3 includes four sections that each include items that are categorized based on the way in which the items were selected. However, these examples are merely illustrative. In various embodiments, a real or virtual shopping cart may include any number of sections and any number of corresponding categories of items. In one example, items in pre-filled shopping cart 200 may be arranged according to item type (e.g., food items, non-food items, perishable items, non-perishable items, flammable items, hazardous items, etc.). A user may add items to a pre-filled shopping cart or remove any unwanted items that have been included in a pre-filled shopping cart.

Although shopping cart 200 of FIGS. 2 and 3 is depicted as a real physical shopping cart (e.g., a shopping cart at a physical store location), it should be appreciated that cart 200 may be a virtual shopping cart on a merchant website or application (e.g., a stored list of items associated with the user and ready for checkout) or an internal purchase order (e.g., a drink order displayed to a barista at a coffee shop on an order display).

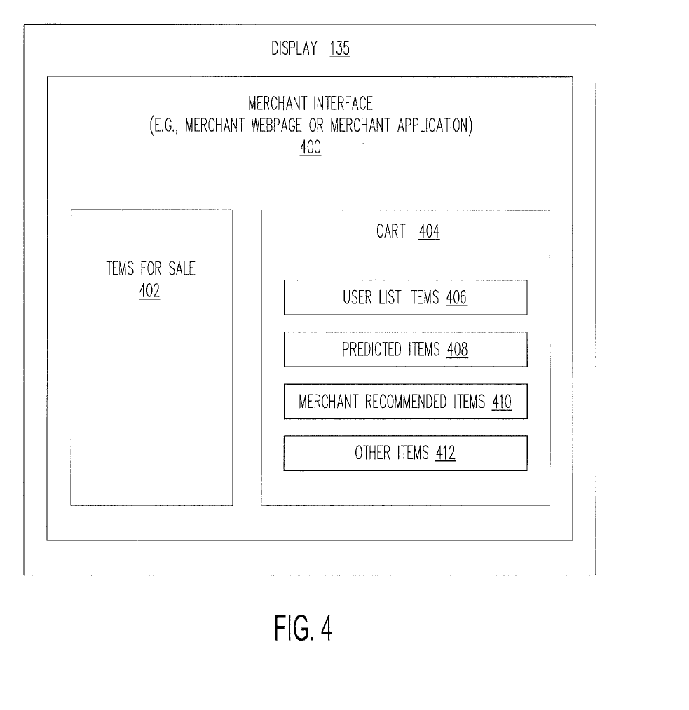

FIG. 4 shows an example of a pre-filled virtual shopping cart. As shown in FIG. 4, a merchant interface 400 (e.g., a merchant webpage or a merchant application on a user's device) may be displayed to a user on display 135 of user device 110. Merchant interface 400 may display items for sale 402 (e.g., items that are not included in the user's virtual shopping cart) and virtual shopping cart 404. As shown, virtual shopping cart 404 may be pre-filled with virtual representations 406, 408, 410, and 412 respectively of user list items, other predicted items, merchant-recommended items, and other items as described above in connection with, for example, FIG. 3. Pre-filled virtual shopping cart 404 may be provided to the user when the user accesses merchant interface 400. In this way, the time the user would otherwise spend filling virtual shopping cart 404 with items 406, 408, and/or 410 can instead be spend browsing items for sale 402. Virtual shopping cart 404 may be edited by a user by adding items for sale 402 to virtual shopping cart 404 and/or, if desired, removing unwanted items that have been pre-filled in virtual shopping cart 404.

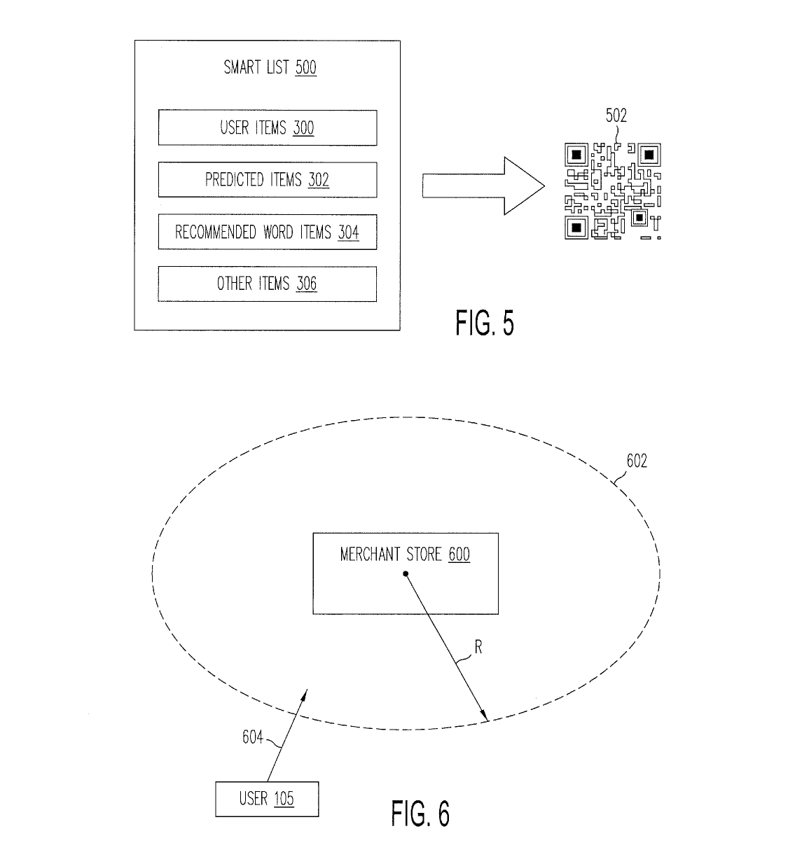

Any or all of the items that are pre-populated in a pre-filled shopping cart such as shopping cart 200 and/or shopping cart 404 may be included on a smart shopping list for a user. FIG. 5 shows an example of a smart shopping list that can be transformed into a scannable code. As shown in FIG. 5, user list items (user items) 300, predicted items 302, and merchant-recommended items (recommended items) 304, and any other items (e.g., other items 306) may be included on a smart shopping list such as smart list 500. An efficient shopping system as described herein may be used to aggregate items onto smart shopping list 500 and transform the smart shopping list (e.g., a human readable list of purchasable items) in to a scannable code such as QR code 502. In various embodiments, smart list 500 may be transformed into any suitable scannable or transmittable code by user device 110, merchant server 140, and/or payment service provider server 170.

In some embodiments, a merchant may pre-fill a shopping cart for a user based on information such as user location information. The user location information may be information associated with the user's arrival at the merchant. User location information may include a transmitted code containing a smart shopping list that is transmitted to the merchant when the user is within a given distance from the merchant or may include geographical location information such as global positioning system coordinates that indicates that the user is within a given distance of the merchant. The information, when received, may cause the merchant to access the user's smart shopping list on the merchant's own server and/or on a payment provider server and pre-fill an order for the user (e.g., in a pre-filled shopping cart) prior to arrival of the user at the merchant.

FIG. 6 is a diagram illustrating a location-based efficient shopping transaction based on a location of a user. As shown in FIG. 6, a merchant may have a brick-and-mortar physical point of sale store such as merchant store 600. According to an embodiment, a system such as system 100 may determine a perimeter 602 around store 600. Perimeter 602 may have any suitable size or shape such as a size defined by a radius R. Radius R may, for example, be one mile, ten miles, ten feet, 100 feet, or any other suitable distance that allows the merchant time to pre-fill a shopping cart for a user before the user arrives. Perimeter 602 may be the same as the actual perimeter of the store 600, may be larger than the physical perimeter of the store 600 or may enclose an area within the store 600. As shown, a user such as user 105 may move in a direction such as direction 604 toward merchant store 600. While moving in direction 604, the user may cross perimeter 602. A user device of the user may automatically transmit information to the merchant's server when the user crosses perimeter 602. The transmitted information may be a coded smart shopping list to be used for pre-filling the user's shopping cart or may be a location alert that informs the merchant that the user is approaching the merchant store. The location alert may cause automatic equipment and/or employees at the merchant store to access the user's smart list on the merchant's server or on a payment provider server and fill the user's shopping cart with the items on the user's smart shopping list prior to arrival of the user.

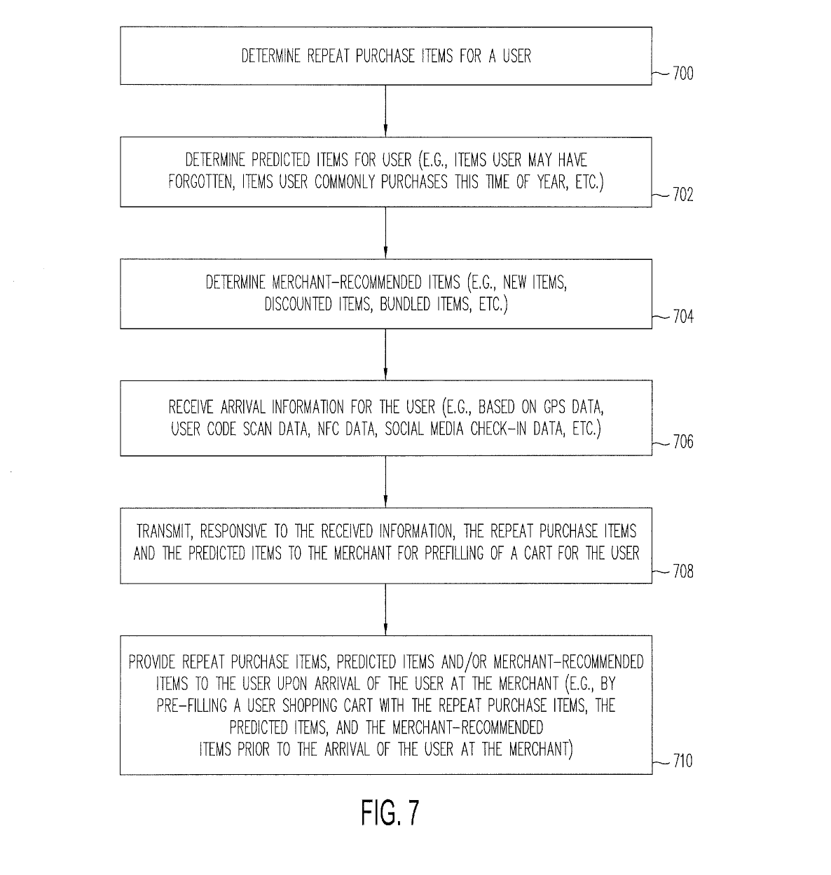

FIG. 7 is a flowchart showing illustrative operations in a process for efficient shopping that includes pre-filling a shopping cart for a user according to one embodiment.

At step 700, a system such as system 100 may determine one or more repeat purchase items for the user. The system may determine the one or more repeat purchase items by accessing a smart shopping list of the user, receiving a list of repeat purchase items from the user, and/or predicting the repeat purchase items by aggregating a list of one or more items that the user has repeatedly purchased from a particular merchant. The repeat purchase items may include one or more of user list items 300 of FIGS. 2, and 3.

At step 702, the system may determine other predicted items for the user such as predicted items 302 (e.g., items the user may have forgotten to purchase, items the user commonly purchases at this time of year, or other predicted items as described herein). The system may determine the predicted items based on one or more detected behaviors of the user such as a detected user location, a user location history, and/or a user purchase history (as examples).

At step 704, the system may determine merchant-recommended items such as merchant-recommended items 304 (e.g., items selected for the user based on the user shopping list, user purchase history, time information, date information, discount information, bundle information, or other user or merchandise availability information).

At step 706, the system may receive information associated with an arrival of the user at a merchant. The information may include global positioning system (GPS) data, user code scan data, near field communication (NFC) data such as user beacon communications, social media check-in data, or other location information (e.g., one or more detected purchases at another nearby merchant) that indicates, for example, that the user will soon arrive or has arrived at the merchant's location. The system may, for example, detect a proximity of the user to a location such as the proximity of the user to a merchant store. The information received may include information from a user device of the user that indicates that the user has crossed a predetermined perimeter around the merchant moving in the direction of the merchant.

At step 708, responsive to the received information, the system may transmit a list of repeat purchase items and/or other predicted items to the merchant for pre-filling of a cart for the user prior to or upon the user's arrival at the merchant. For example, a payment provider server that has generated a list of predicted items for a user such as repeat purchase items, other predicted items, or other items as described herein may transmit the list of items to the merchant for pre-filling of a shopping cart.

At step 710, the repeat purchase items, the other predicted items, and/or the merchant-recommended items may be provided to the user upon arrival of the user at the merchant. The repeat purchase items, the predicted items, and/or the merchant-recommended items may be provided to the user by, for example, pre-filling a user shopping cart with the repeat purchase items, the predicted items, the merchant-recommended items and/or other items for the user, prior to the arrival of the user at the merchant and providing the pre-filled shopping cart to the user upon arrival of the user at the merchant. The repeat purchase items, other predicted items, and/or other items may, according to an embodiment, be selected for pre-filling in the shopping cart based on the transmitted list of items. The merchant-recommended items may be selected by the merchant for inclusion in the pre-filled shopping cart by the merchant in addition to the items on the transmitted list of items.

In some embodiments, the system may predict items for the user based on the user's behavior. In one example, based on a user's pattern of movements, the system can learn the user's habits such as merchants at which the user regularly shops, when the user typically shops (e.g., Vons on Sunday morning), etc. Based on these learned behaviors, and the particular merchant, a cart may be pre-filled at the merchant before the user arrives.

For example, if it is determined (e.g., based on the user's purchase history, location, and/or location history) that the user is planning a camping trip, camping related items may be predicted for the user. For example, the system may detect that the user has purchased a tent and firewood and is approaching a big box store at which the user frequently shops. The system may then predict that the user may need a hatchet, a knife, a compass, or other camping-related items. The system can cause the merchant to provide the predicted items in a pre-filled shopping cart prior to the user's arrival at the merchant or, in some embodiments, offer to deliver the predicted items to the user.

In another embodiment, one or more repeat or periodic purchases may be predicted as being needed sooner or later than a regular period for purchase. For example, a user may typically purchase toilet paper every month, but the system may predict the user may need toilet paper sooner because user data has indicated the user is currently having relatives staying with the user. In another case, the system may predict the user will not need toilet paper in the current month because it detects that the user's wife has recently purchased toilet paper. Thus, data available from user purchases, household purchases by others, social network data, calendar events (such as house guests staying), etc., may be used to adjust a predicted periodic purchase.

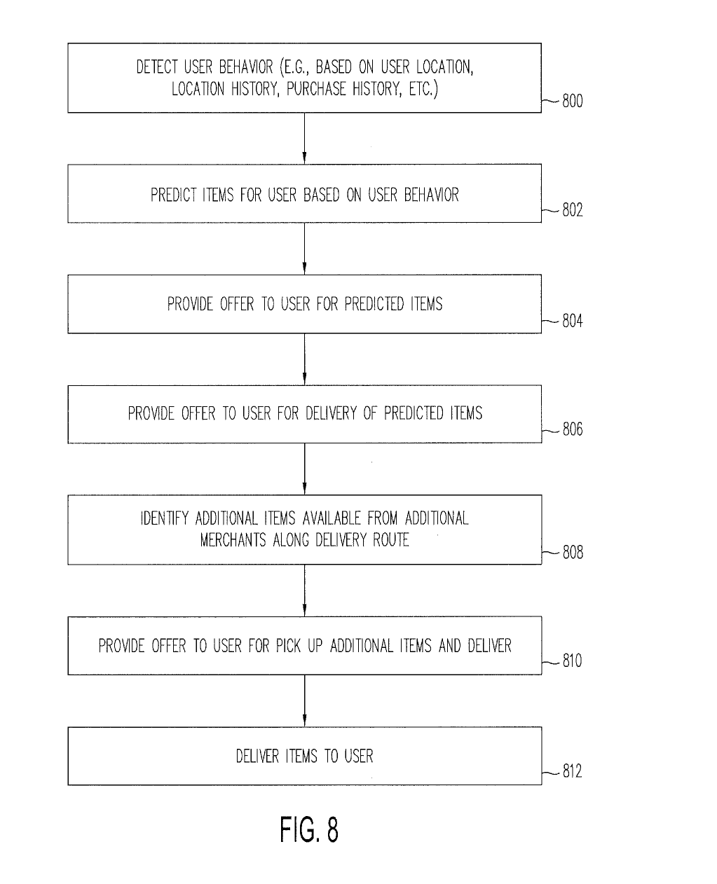

FIG. 8 is a flowchart of illustrative steps that may be used in performing efficient shopping operations based on detected user behavior.

At step 800, a user behavior may be detected (e.g., by one or more servers of system 100) based on, for example, location data such as GPS data from a user device of the user, location history, user code scan data received when a user scans a code at a merchant, near field communications (NFC) data such as transmitted signals to or from a beacon, or other information associated with the user (e.g., user purchases, user communications such as email communications, social networking communications, or other online or offline communications). A detected user behavior may be trip planning behavior, illness related behavior, home improvement behavior, party planning behavior, or other behavior that indicates a current or planned condition or activity of the user.

In one example, the user behavior may be a lack of movement at a time when the user is normally moving or a detection that the user is at home during a time when then user is normally at work or at school that indicates that the user may be ill. In another example, it may be detected that the user has visited and/or made purchases at one or more home improvement supply stores that indicate that the user is (or is preparing to) renovate a portion of their home.

At step 802, items for purchase for the user may be predicted based on the detected user behavior. The predicted items may be items associated with the user behavior such as additional items for purchase associated with the current or planned condition or activity of the user. For example, it may be predicted that a user that has purchased a new bathroom sink at a home improvement supply store using a payment server may also need paint, paint brushes, faucet handles, caulking, tools such as specialized tools or other items for renovating a home bathroom that the user has not yet purchased and/or items for purchase that are not available at the locations the user has visited.

At step 804, an offer may be provided to the user for the predicted items. In one embodiment, providing an offer for the predicted items for the user may include providing the predicted items in a pre-filled shopping cart when the user visits a merchant. The items that have been predicted based on the user behavior may be provided to the user in a corresponding section of a pre-filled shopping cart that also includes other items in other corresponding sections of the shopping cart such as user list items, repeat purchase items, merchant-recommended items, or other items for the user. In another example, the offer may be provided to the user for the predicted items by providing an alert to the user (e.g., to a user device of the user) that the predicted items are available for purchase. For example, an alert may be provided to the user device with a list of the predicted items, prices, and, if desired, reasons for the predictions. For example, an alert may read, “Hello! We've detected that you may be remodeling your bathroom. These items may be helpful.”

At step 806, an offer may be provided to the user for delivery of the predicted items. An offer for deliver may be made whenever items are predicted for the user, or based on the detected user behavior. For example, a detected user behavior that indicates that the user is unable to visit a merchant or that visiting a merchant would be inconvenient may cause the system to generate a delivery offer. For example, an alert for the user for the predicted items (or a separate alert) may read, “Would you like us to deliver these items?” The offer for delivery may include various selectable delivery times (e.g., same day delivery, next day delivery, two-day delivery, etc.) and/or a decline delivery option.

At step 808, additional items may be identified that are available from additional merchants that are located along the delivery route to the user. For example, in some situations, one or more predicted items may not be available at a particular merchant from which a delivery for a user is being made. The system may then access servers of additional merchants that are located on or near the delivery route to determine whether the predicted items are available at those merchants. In another example, additional items may be predicted for the user based on the presence of additional merchants on or near the delivery route.

At step 810, an additional offer for pickup and delivery of the additional items may be provided to the user. However, this is merely illustrative. If desired, an offer for pickup and delivery of the additional items may be made as a portion of a first offer for predicted items at step 804.

At step 812, the items and/or the additional items may be delivered to the user. The items and/or the additional items may be delivered in response to receiving delivery instructions from the user. The user may provide delivery instructions that indicate when and where the user would like the items and/or the additional items to be delivered and/or the system may access a user account stored on, for example, a merchant server or a payment provider server to obtain delivery preferences. The system may also process payment for the items and/or the additional items using, for example, a payment provider server.

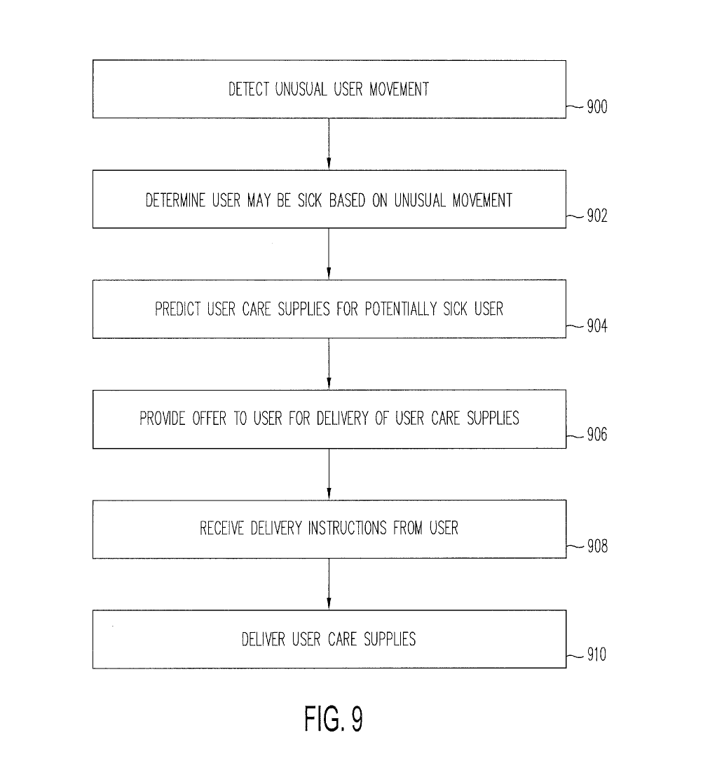

In one situation that is described herein as an example, the detected user behavior may be an unusual movement or lack of movement by the user that indicates that the user may be sick. The system may identify and provide predicted items such as user care items for the user in response to determining that a user may be ill or injured. Exemplary steps that may be taken to identify and provide predicted items such as user care items for a user based on an unusual user movement are shown in FIG. 9

FIG. 9 is a flowchart of illustrative steps that may be involved in providing user care items to a user according to an embodiment.

At step 900, an unusual user movement may be detected by, for example, a system such as system 100 of FIG. 1. The unusual movement may include, for example, an unusual location of the user (e.g., the user may be at home when the user is usually at work or at school) or an unusual lack of movement at a time when the user is normally moving. The unusual movement may be detected based on, for example, location data such as GPS data from a user device of the user, user code scan data received when a user scans a code at a merchant, near field communications (NFC) data such as transmitted signals to or from a beacon, or other information associated with the user (e.g., user purchases, user communications such as email communications, social networking communications, or other online or offline communications) that indicates unusual movements. Detecting the unusual behavior may include gathering user location data over a period of time prior to the detecting and comparing user location data at the time of detecting with the gathered user location data (e.g., location history data).

At step 902, it may be determined that the user may be sick based on the unusual lack of movement. For example, on a weekday when the user is at a work location greater than 90%, greater than 95%, or greater than 99% (as examples) of the time, the user is detected as being at home, the system may determine that the user is sick. In some embodiments, the system may send a query to the user asking the user if the user is sick. In other embodiments, the system may integrate additional data such as user purchase history data (e.g., detection of a payment for cold medicine) in determining that the user may be sick.

At step 904, user care supplies for the potentially sick user may be predicted. For example, predicted user care supplies may include medications, food, or medical supplies associated with a general or specific medical condition.

At step 906, an offer may be provided to the user for delivery of the user care supplies. For example, an alert may be provided to the user on the user device that reads “We noticed you aren't at work today. Would you like any of the items listed to be delivered to you today?” The alert may include a list of the predicted user care items.

At step 908, the system may receive delivery instructions from the user. The delivery instructions may be provided to the system when, using the user device, the user selects one or more of the predicted user care items for delivery and selects a delivery time and address or the delivery instructions may include an instruction to deliver the items using user delivery preferences already stored in a user account.

At step 910, responsive to receiving the delivery instructions from the user, the items may be delivered according to the user instructions. In this way, the system may reduce the effort and increase the efficiency with which a user obtains care supplies when the user is sick.

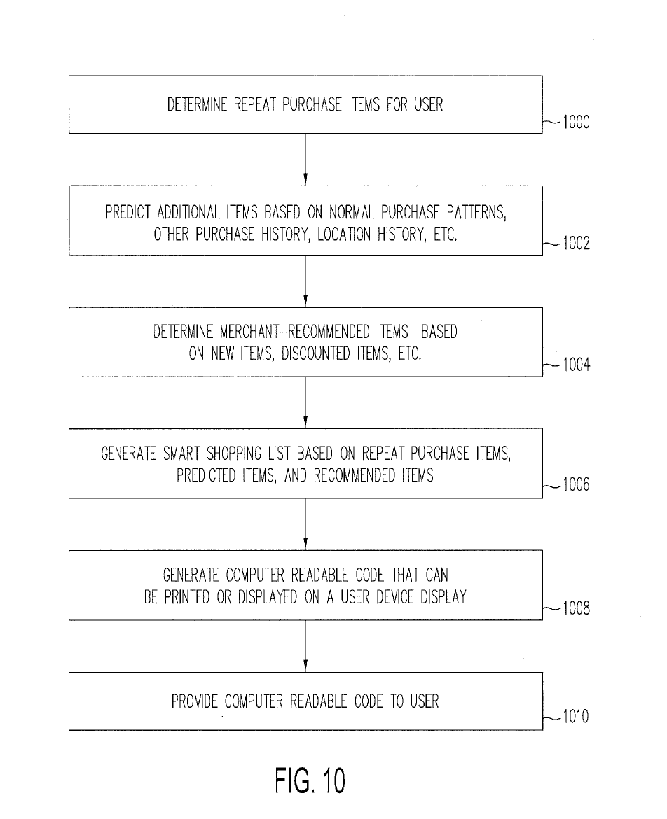

FIG. 10 is a flowchart of illustrative steps that may be involved in generating a smart shopping list of the type shown in FIG. 5.

At step 1000, the system may determine one or more repeat purchase items that the user repeatedly purchases when visiting a merchant. The repeat purchase items may include some or all of user list items 300 as described herein.

At step 1002, additional items such as predicted items 302 or other items may be predicted for the user based on normal purchase patterns, the user's purchase history, a location history of the user, a current location of the user, a detected user behavior, or other user information (e.g., email and/or social network communications).

At step 1004, merchant-recommended items such as merchant-recommended items 306 as described herein may be determined based on (as examples), new items, discounted items, or other items such as bundled items.

At step 1006, a smart shopping list for the user may be generated based on the repeat purchase items, the user list items, the predicted items, and the merchant-recommended items. For example, the repeat purchase items, the user list items, the predicted items, the merchant-recommended items and other items may be combined to form the smart shopping list and, according to some embodiments, other items may be added to the smart shopping list based on the user list items, the predicted items, and the merchant recommended items.

At step 1008, a computer readable code such as a QR code may be generated based on the smart shopping list. The computer readable code may be a visually scannable code that can be printed and/or displayed on a display such as display 135 of user device 110.

At step 1010, the computer readable code may be provided to the user. As examples, the computer readable code can be generated by a payment provider application running on the user device, by another application running on the user device, by the payment provider server or by the merchant server. Computer readable codes generated by remote servers (e.g., a merchant server or a payment provider server) may be transmitted to the user device and stored on the user device.

A computer readable code of the type generated using steps 1000-1010 of FIG. 10 can be scanned by a user when the user arrives at a merchant location so that the items on the list can be provided to the user. For example, the user may scan a computer readable code using a merchant code scanner upon arrival at the merchant and, responsive to the scanned code, receive a pre-filled shopping cart with the smart shopping list items and/or receive the smart shopping list items without a shopping cart (e.g., a food or drink order represented by the code may be prepared, provided, and charged for the user without any other interaction than scanning the code).

In one embodiment, the smart shopping list and the pre-filled shopping cart may be generated and prepared for the user without any user interaction. For example, the system may learn (based only on aggregated location and/or purchase data gathered over time and, if desired, current location data) the repeat purchase items and the predicted arrival time of the user at a merchant, generate predicted and/or merchant-recommended items, pre-fill a shopping cart with the repeat purchase items, the predicted items, and the merchant-recommended items, and provide the pre-filled shopping cart to the user upon arrival at the merchant. In this way, the efficiency of the user's shopping may be continually increased over time without interaction by the user.

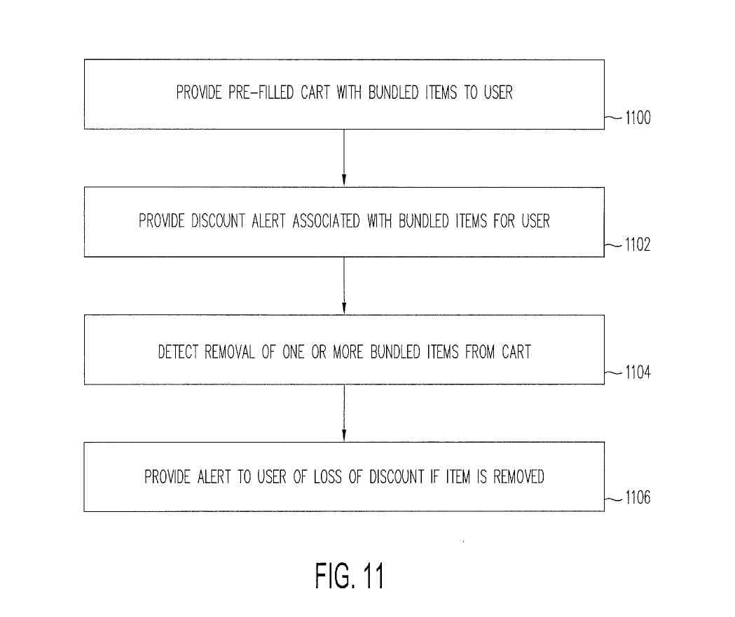

FIG. 11 is a flowchart of illustrative steps that may be involved in providing bundled items to a user for efficient shopping according to an embodiment.

At step 1100, a pre-filled shopping cart that includes bundled items may be provided to a user (e.g., when the user arrives at a merchant location). The bundled items may include one or more items from a user provided list, one or more repeat purchase items, one or more predicted items, and/or one or more merchant-recommended items that, when purchased together, can be purchased at a discounted price.

At step 1102, a discount alert associated with the bundled items may be provided to the user. For example, an application running on the user's smart phone may read “The following items in your pre-filled shopping cart, when purchased together, are offered at a 10% discount.”

At step 1104, removal of one or more of the bundled items from the pre-filled shopping cart may be detected (e.g., by the user device or by sensors in the cart or elsewhere in the merchant location).

At step 1106, responsive to the detected removal, an alert may be provided to the user of a loss of the discount on other items bundled with that item if the item is removed from the cart. For example, an alert displayed on the user's smart phone may read “We've noticed that you removed an item from your pre-filled shopping cart. If you remove that item, the 10% discount on these other items will be lost!”

In general, the steps described above in connection with FIGS. 6, 7, 8, 9, 10, and 11 may be performed in any suitable order and/or combined in any suitable way for facilitating efficient shopping.

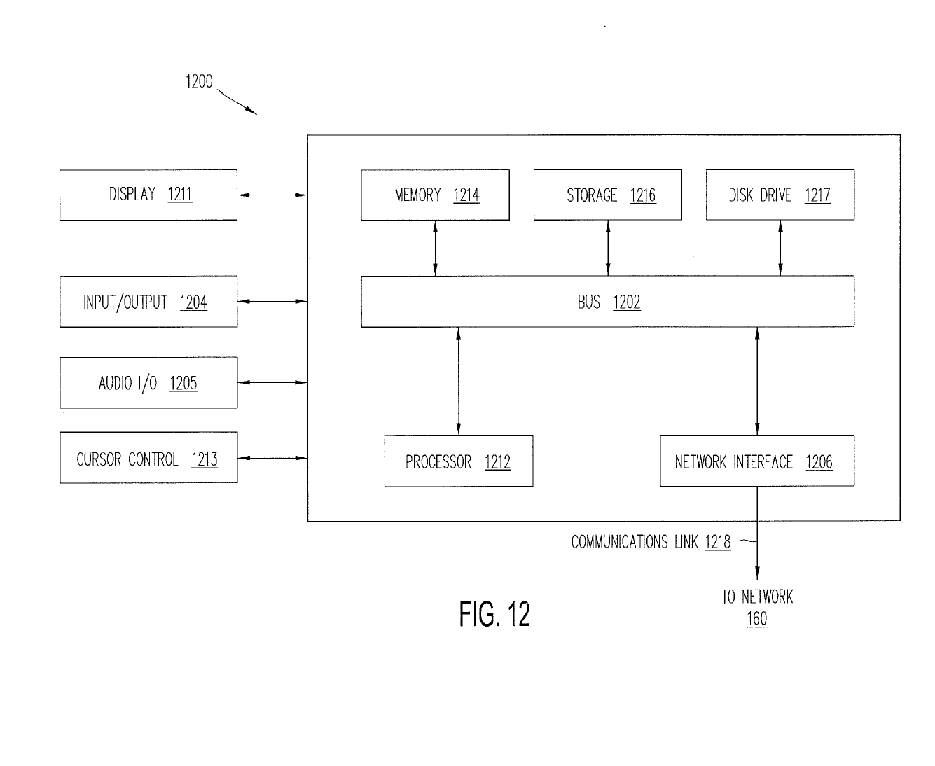

FIG. 12 is a block diagram of a computer system 1200 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 1200 in a manner as follows.

Computer system 1200 includes a bus 1202 or other communication mechanism for communicating information data, signals, and information between various components of computer system 1200. Components include an input/output (I/O) component 1204 that processes a user action, such as selecting keys from a keypad/keyboard, selecting one or more buttons or links, etc., and sends a corresponding signal to bus 1202. I/O component 1204 may also include an output component, such as a display 1211 and a cursor control 1213 (such as a keyboard, keypad, mouse, etc.). An optional audio input/output component 1205 may also be included to allow a user to use voice for inputting information by converting audio signals. Audio I/O component 1205 may allow the user to hear audio. A transceiver or network interface 1206 transmits and receives signals between computer system 1200 and other devices, such as another user device, a merchant server, or a payment provider server via network 160. In one embodiment, the transmission is wireless, although other transmission mediums and methods may also be suitable. A processor 1212, which can be a micro-controller, digital signal processor (DSP), or other processing component, processes these various signals, such as for display on computer system 1200 or transmission to other devices via a communication link 1218. Processor 1212 may also control transmission of information, such as cookies or IP addresses, to other devices.

Components of computer system 1200 also include a system memory component 1214 (e.g., RAM), a static storage component 1216 (e.g., ROM), and/or a disk drive 1217. Computer system 1200 performs specific operations by processor 1212 and other components by executing one or more sequences of instructions contained in system memory component 1214. Logic may be encoded in a computer readable medium, which may refer to any medium that participates in providing instructions to processor 1212 for execution. Such a medium may take many forms, including but not limited to, non-volatile media, volatile media, and transmission media. In various implementations, non-volatile media includes optical or magnetic disks, volatile media includes dynamic memory, such as system memory component 1214, and transmission media includes coaxial cables, copper wire, and fiber optics, including wires that comprise bus 1202. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 1200. In various other embodiments of the present disclosure, a plurality of computer systems 1200 coupled by communication link 1218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a hardware memory that stores account information of a user; and
at least one processor in communication with the hardware memory, wherein the at least one processor is configured to:
determine at least one predicted purchase item for the user;
receive information that is associated with an arrival of the user at a merchant from a user device of the user; and
transmit, responsive to the information, the at least one predicted purchase item to the merchant for pre-filling a cart for the user.

2. The system of claim 1, wherein the at least one predicted purchase item comprises a repeat purchase item that the user has repeatedly purchased.

3. The system of claim 1, wherein the at least one predicted purchase item is based on a purchase history of the user.

4. The system of claim 1, wherein the at least one predicted purchase item is based on at least one purchase made by someone other than the user.

5. The system of claim 1, wherein the at least one predicted purchase item is based on a detected user behavior.

6. The system of claim 1, wherein the at least one predicted purchase item is based on social network data.

7. The system of claim 1, wherein the at least one predicted purchase item is based on a calendar event stored on the user device.

8. The system of claim 1, wherein the at least one processor is further configured to determine a merchant-recommended item for the user.

9. The system of claim 8, wherein the merchant-recommended item is bundled with the at least one predicted purchase item and offered at a discounted price.

10. The system of claim 8, wherein the at least one processor is configured to determine the at least one predicted purchase item based in part on an availability of the predicted purchase item at the merchant.

11. The system of claim 1, wherein the information includes location information received when the user checks in with the merchant using a social media application.

12. The system of claim 1, wherein the information comprises location information based on global positioning system data from the user device.

13. The system of claim 1, wherein the at least one processor is further configured to generate a scannable code that represents a smart shopping list containing the at least one predicted purchase item.

14. A method, comprising:
determining, electronically by one or more processors, at least one predicted purchase item for a user;
receiving, electronically by the one or more processors, information that is associated with an arrival of the user at a merchant from a user device of the user; and
transmitting, electronically by the one or more processors and responsive to the receiving, the at least one predicted purchase item to the merchant for pre-filling a cart for the user.

15. The method of claim 14, further comprising pre-filling the cart with the at least one predicted purchase item prior to the arrival of the user at the merchant.

16. The method of claim 15, wherein the receiving comprises receiving a scanned code representing the at least one predicted purchase item.

17. The method of claim 15, wherein the receiving comprises receiving location information from the user device of the user.

18. The method of claim 15, wherein the pre-filling further comprises pre-filling the cart with at least one merchant-recommended item.

19. The method of claim 14, further comprising:
pre-filling the cart with the at least one predicted purchase item, at least one other predicted item, and at least one merchant-recommended item in corresponding sections of the cart prior to the arrival of the user at the merchant; and
providing the pre-filled cart to the user upon the arrival of the user at the merchant.

20. The method of claim 19, further comprising:
allowing user removal of an unwanted item from the pre-filled cart.

21. The method of claim 19, wherein the at least one merchant-recommended item comprises first and second bundled items, the method further comprising:
offering a discount on the first and second bundled items;
detecting a removal of the first bundled item; and
alerting the user to a loss of the discount on the second bundled item if the first bundled item is removed.

22. A non-transitory machine-readable medium having a plurality of machine-readable instructions which, when executed by one or more processors of a server, are adapted to cause the server to perform a method comprising:
determining at least one predicted purchase item for a user;
receiving information that is associated with an arrival of the user at a merchant from a user device of the user; and
transmitting, responsive to the receiving, the at least one predicted purchase item to the merchant for pre-filling a cart for the user.

23. The non-transitory machine-readable medium defined in claim 22, wherein the method further comprises detecting a user behavior based on a user location history and a user purchase history and wherein the determining further comprises determining the at least one predicted purchase item for the user based on the detecting.
